(19) United States
(12) Patent Application Publication
(10) Pub. No.: US 2025/0377326 A1
(43) Pub. Date: Dec. 11, 2025

(54) MEASUREMENT OF ELECTRICAL PROPERTIES OF POWDER SAMPLE DURING RHEOLOGICAL TESTING

(71) Applicant: TA Instruments-Waters LLC, New Castle, DE (US)

(72) Inventor: Scott Merrullo, Newark, DE (US)

(21) Appl. No.: 19/229,227

(22) Filed: Jun. 5, 2025

Related U.S. Application Data
(60) Provisional application No. 63/656,789, filed on Jun. 6, 2024.

(51) Int. Cl. G01N 27/04; G01N 11/14; G01N 27/22

(52) U.S. Cl. CPC G01N 27/043; G01N 11/14; G01N 27/22

(57) ABSTRACT

An apparatus for performing electrical and rheological measurements of a powder sample includes an upper geometry including a first electrode, a lower geometry including a bottom surface and a second electrode, a sidewall forming a perimeter located between the upper geometry and the bottom surface of the lower geometry, a sample gap located between the upper geometry and the lower geometry and within the perimeter of the sidewall, the powder sample locatable in the sample gap such that the first electrode and the second electrode are in contact with the powder sample, an electrical measurement system operably connected to each of the first electrode and the second electrode configured to measure electrical properties of the powder sample during a rheological test, and a mechanical measurement system configured to measure mechanical properties of the powder sample located in the sample gap during the rheological test.

### RELATED APPLICATION

This application claims priority to U.S. Provisional Patent Application No. 63/656,789 filed on Jun. 6, 2024 and titled “Measurement of Electrical Properties of Powder Sample During Rheological Testing” the entirety of which is incorporated by reference herein.

### FIELD OF THE INVENTION

The disclosed technology generally relates to a device for measuring properties of materials. More particularly, the technology relates to the measurement of electrical properties of a powder sample during rheological testing.

### BACKGROUND

Rheometers are well-known for measure the relationships between stress and strain or strain rate by measuring the displacement, and more specifically torque, of a moving measurement in a finite sample volume defined by an upper and lower geometry, generally in the form of plates or the like, over a measured period of time. These measurements are often performed with an actively controlled temperature.

It is often desirable to perform electrical measurements in-situ during rheological measurements to correlate the electrical and rheological measurements. To enable such measurements, an electric field is established in the sample and electrical properties are measured during rheological measurements. Current state of the art systems achieve concurrent electrical and rheological measurements by using the moving and stationary geometries of a rheological instrument as electrodes of opposite polarity such that electrical current flows from one electrode through the sample to the other electrode.

Electrical properties of a powder may be affected by exposure to shearing stresses and strains, or other mechanical forces (e.g., compression). These electrical properties may be important for many powders that experience these mechanical forces during processing and/or end-use applications, such as battery electrode powders. However, there are no state of the art rheological methods or devices that comprehensively measure the relationship between mechanical forces and electrical properties in powders. In particular, there are no state of the art rheological methods or devices that measure the relationship between shear stresses and/or strain history and the electrical properties in powders.

Therefore, devices and methods for the measurement of electrical properties of powder samples during rheological testing, and more particularly during shearing of the sample, would be well received in the art.

### SUMMARY

In one aspect, an apparatus for performing electrical and rheological measurements of a powder sample, includes an upper geometry including a first electrode, a lower geometry including a bottom surface and a second electrode where the upper geometry is configured to rotate relative to the lower geometry, a sidewall forming a perimeter located between the upper geometry and the bottom surface of the lower geometry, a sample gap located between the upper geometry and the lower geometry and within the perimeter of the sidewall, the powder sample locatable in the sample gap such that the first electrode and the second electrode are in contact with the powder sample, an electrical measurement system operably connected to each of the first electrode and the second electrode configured to measure electrical properties of the powder sample during a rheological test, and a mechanical measurement system configured to measure mechanical properties of the powder sample located in the sample gap during the rheological test.

In another aspect, a method for performing electrical and rheological measurements of a powder sample, includes providing an apparatus for performing electrical and rheological measurements of a powder sample, the apparatus including an upper geometry, a lower geometry, a sidewall forming a perimeter between the upper geometry and the lower geometry, and a sample gap located between the upper geometry and the lower geometry and within the perimeter of the sidewall, providing a powder sample within the sample gap such that the first electrode and the second electrode are in contact with the powder sample, performing a rheological test on the powder sample, measuring, by an electrical measurement system connected to each of the first electrode and the second electrode, electrical properties of the powder sample during the rheological test, and measuring, by a mechanical measurement system, mechanical properties of the powder sample during the rheological test.

In another aspect an apparatus for performing electrical and rheological measurements of a powder sample includes an upper geometry, a lower geometry where the upper geometry is configured to rotate relative to the lower geometry, a sidewall forming a perimeter located between the upper geometry and the lower geometry, a sample gap located between the upper geometry and the lower geometry and within the perimeter of the sidewall, the powder sample locatable in the sample gap such that a first electrode and a second electrode are in contact with the powder sample, an electrical measurement system operably connected to each of the first electrode and the second electrode configured to measure electrical properties of the powder sample during a rheological shear test, and a mechanical measurement system configured to measure mechanical properties of the powder sample located in the sample gap during the rheological shear test.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1 depicts a schematic view of a known rheometer used to measure rheological and electrical properties of a sample.

FIG. 1B depicts a perspective view of a known rheometer used to measure shear strength of a powder sample.

FIG. 2 depicts a side schematic view of a rheometer that includes electrodes for the measurement of electrical properties of powder samples during rheological testing, in accordance with one embodiment.

FIG. 3 depicts a side schematic view of another rheometer that includes electrodes for the measurement of electrical properties of powder samples during rheological testing, in accordance with one embodiment.

FIG. 4 depicts a side schematic view of another rheometer that includes electrodes for the measurement of electrical properties of powder samples during rheological testing, in accordance with one embodiment.

FIG. 5 depicts a side schematic view of another rheometer that includes electrodes for the measurement of electrical properties of powder samples during rheological testing, in accordance with one embodiment.

FIG. 6 depicts a side schematic view of another rheometer that includes electrodes for the measurement of electrical properties of powder samples during rheological testing, in accordance with one embodiment.

FIG. 7A depicts the results of a mechanical rheological shear test on a powder sample.

FIG. 7B depicts further results from the mechanical rheological shear test of FIG. 7A.

FIG. 8A depicts the results of a mechanical rheological wall friction test on a powder sample.

FIG. 8B depicts further results from the mechanical rheological wall friction test of FIG. 8A.

FIG. 8C depicts further results from the mechanical rheological wall friction test of FIG. 8A.

FIG. 9A depicts the results of a mechanical rheological compressibility test on a powder sample.

FIG. 9B depicts further results from the mechanical rheological compressibility test of FIG. 9A.

FIG. 9C depicts further results from the mechanical rheological compressibility test of FIG. 9A.

FIG. 10A depicts the results of a mechanical rheological flow test on a powder sample.

FIG. 10B depicts further results of the mechanical rheological flow test of FIG. 10A.

FIG. 10C depicts further results of the mechanical rheological flow test of FIG. 10A.

FIG. 10D depicts further results of the mechanical rheological flow test of FIG. 10A.

### DETAILED DESCRIPTION

Reference in the specification to an embodiment or example means that a particular feature, structure or characteristic described in connection with the embodiment or example is included in at least one embodiment or example of the teaching. References to a particular embodiment or example within the specification do not necessarily all refer to the same embodiment or example.

The present teaching will now be described in detail with reference to exemplary embodiments or examples thereof as shown in the accompanying drawings. While the present teaching is described in conjunction with various embodiments and examples, it is not intended that the present teaching be limited to such embodiments and examples. On the contrary, the present teaching encompasses various alternatives, modifications, and equivalents, as will be appreciated by those of skill in the art. Moreover, features illustrated or described for one embodiment or example may be combined with features for one or more other embodiments or examples. Those of ordinary skill having access to the teaching herein will recognize additional implementations, modifications, and embodiments, as well as other fields of use, which are within the scope of the present disclosure as described herein.

Various terminology is used in the following description. As used herein, the term “geometry” relates to one or more components used to generate the desired stress or strain in a sample. For example, for a sample disposed between two horizontally arranged parallel plates where one of the plates rotates with respect to the other plate, the rotating plate may be referred to as the moving geometry and the stationary plate referred to as the stationary geometry. Alternatively, one plate may simply be referred to as the upper geometry while the other plate is referred to as the lower geometry. Similarly, geometries are associated with other rheometer arrangements such as concentric cylinders in which one cylinder remains stationary while the other cylinder rotates about the cylinder axis. For example, embodiments described herein include geometries which include side walls for maintaining a powder sample within a defined geometric space and measuring shear stresses and/or strains.

As used herein, “electrode” means an electrically conductive element used to establish an electric field between the element and another electrically conductive element. In the examples described below, an electrode can refer to an electrically conductive component such as a metal plate geometry in a parallel plate rheometer or part or all of a wall in a double walled cup measurement geometry.

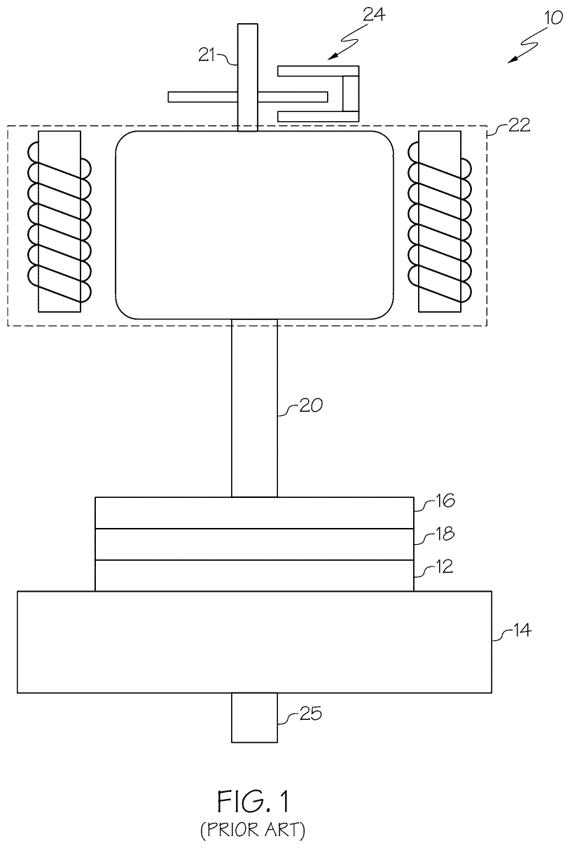

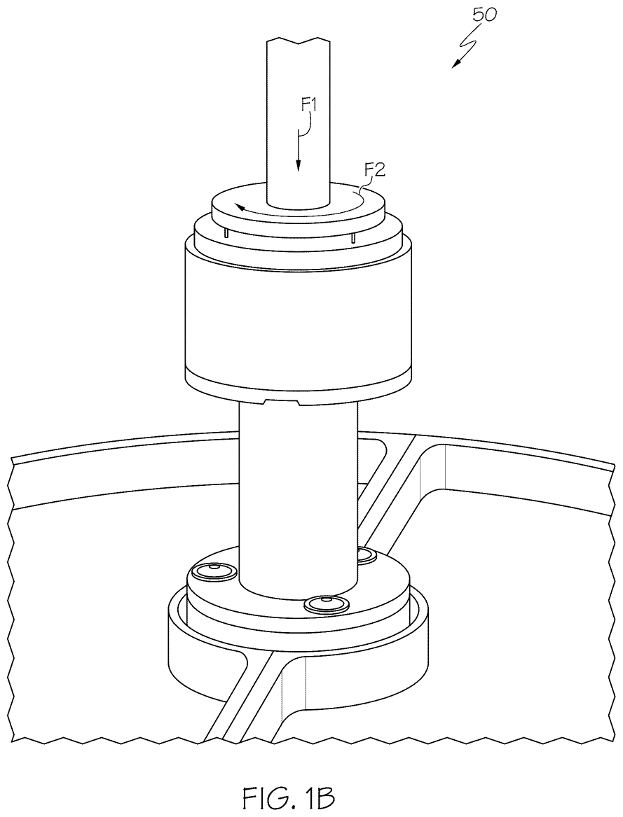

FIG. 1 is a schematic depiction of a known rheometer 10 that can be used to measure rheological and electrical properties of a sample. The rheometer 10 includes a lower stationary geometry 12 on a larger plate or block 14 which is attached to a stationary lower shaft 25. In some implementations, thermal control of the sample temperature can be achieved via a thermal controller in thermal communication with the lower geometry through the plate 14. The rheometer 10 further includes an upper geometry 16 separated from the lower geometry 12 by a sample gap which is occupied by the sample 18 under test. A shaft 20 couples the upper geometry 16 to a combined motor transducer 22 that is cushioned by air and levitated. The current supplied to the motor 22 provides the torque to rotate the upper geometry 16. A sensor system 24 which includes a rotating component 21 configured to rotate with the shaft 20 provides a means of sensing the rotational displacement. Further, the motor 22 may be configured to provide vertical displacement of the shaft 20 and the upper geometry 16 relative to the lower geometry 12. The sensor system 24 may further be configured to detect this vertical displacement. To generate an electric field across the sample 18, a voltage difference may be applied across the lower and upper geometries 12, 16. This is achieved by electrically coupling the lower geometry 12 to a terminal of a voltage source and electrically coupling the upper moving geometry 16 to the other terminal of the voltage source. FIG. 1B depicts a perspective view of a known rheometer 50 used to measure shear strength of a powder sample which is configured to apply both a compressive force F1 and a rotational force F2.

In brief overview, embodiments and examples disclosed herein are directed to a rheological measurement system that is configured to simultaneously measure shear stresses and/or strains and electrical properties of a powder sample. Embodiments herein recognize that the electrical properties of a powder sample may be affected by exposure to shearing stresses and/or strains. For example, shear may be used to intentionally deform, melt or otherwise alter the binder to glue a dry electrode together. Shear may also have unintended negative affects on conductivity due to particle attrition, segregation, etc.

These electrical properties may be important for many powder samples, and particularly those that will experience shearing during processing and/or end user applications, such as in battery electrode powders. Embodiments described herein provide for simultaneous measurement to occur while the powder sample is confined to a well-defined geometry and under well-defined normal stress. This provides for a direct correlation between the electrical properties of the powder sample and the mechanical shear stresses and/or strains the powder sample experiences.

To accomplish measuring electrical properties during shear by creating a voltage across a powder shear cell, embodiments of the present invention propose utilizing electrically insulating side walls such that current and electrical fields flow through the powder sample during exposure to mechanical rheological testing. The insulating side walls may create a cup-shaped structure for maintaining the powder sample within a defined geometric space.

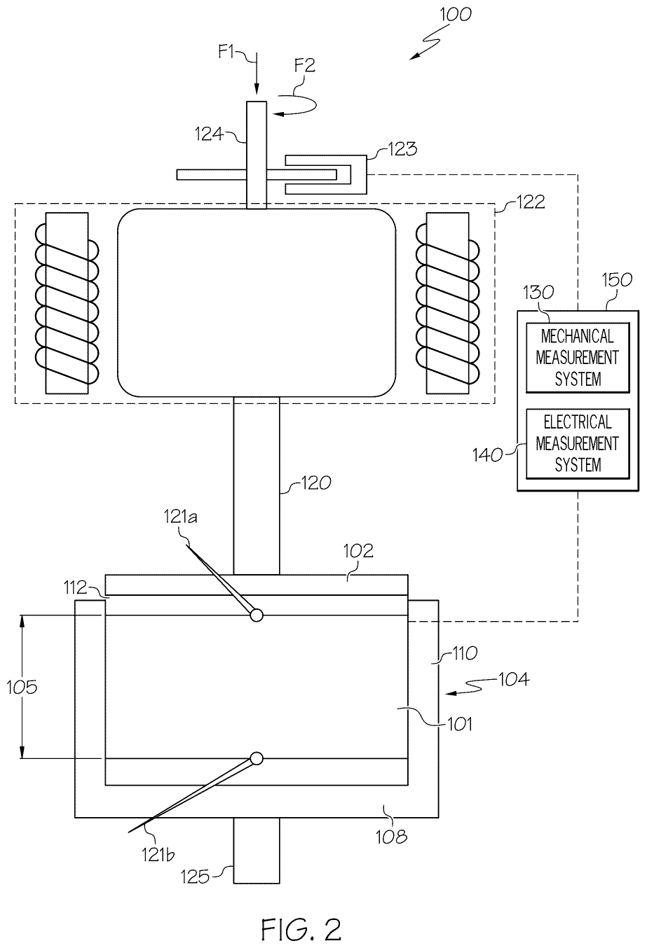

FIG. 2 depicts a side schematic view of a rheometer 100 that includes electrodes for the measurement of electrical properties of powder samples during rheological testing, in accordance with one embodiment. The rheometer 100 includes an upper geometry 102 and a lower geometry 104, each having a specific predetermined geometry for performing measurements. During operation, a powder sample 101 is placed between the geometries 102, 104 which are separated by a gap 105. The gap 105 may be moveable by moving the upper geometry 102 downward or upward relative to the lower geometry 104.

The rheometer includes a shaft 120 that couples the upper geometry 102 to a combined motor transducer 122 that may be cushioned by air and levitated. The current supplied to the motor 122 provides the torque to rotate the upper geometry 102. A system 123 which includes a rotating component 124 configured to rotate with the shaft 120 provides a means of sensing the rotational displacement, vertical displacement and/or forces or torque created by the motor 122 and produced in the shaft 120. For example, the displacement sensor system 123 can include an optical encoder and optical sensor. The motor current is monitored to sense the torque applied to the sample 101. Further, the motor 122 may be configured to provide vertical displacement of the shaft 120 and the upper geometry 102 relative to the lower geometry 106. The sensor system 123 may further be configured to detect this vertical displacement.

During operation, the top geometry 102 rotates and in doing so the motor 122 can provide torque to the sample 101 in order to perform a shear test. The sensor system 123 can measure the rotational rate of the top geometry 102. In some embodiments, an electrical current is applied onto the motor 122 to build up a magnetic field which produces an electrical torque resulting in a rotation of the drive shaft 124. In some embodiments, no separate torque sensor may be needed since the rotational rate of the top geometry 102 and the shaft 120 is measured by the sensor system 123. The viscosity of the sample and measured rotational rate can be used to calculate the stress, or torque, for example, by the computer processor 150 of the rheometer 100.

In the embodiment shown, the upper geometry 102 includes a flat plate having a surface configured to contact the sample powder sample 101 within the sample gap 105. The upper geometry 102 further includes a first electrode 112 configured to contact the powder sample 101. The lower geometry 104 includes a bottom surface 108 which is connected to a lower shaft 125 which may be stationary in some embodiments or movable (both vertically and/or rotationally) in other embodiments. In some embodiments, the lower shaft 125 may be configured to provide for a counter rotation to the rotation of the shaft 120. The bottom surface 108 further includes a second electrode 114 configured to contact the powder sample 101. As shown, the lower geometry 104 includes a sidewall 110 which forms a perimeter and is located between the upper geometry 102 and the bottom surface 108 of the lower geometry 104. The sidewall 110 is a component or feature of the lower geometry 104 in the embodiment shown, thereby creating a cup-shaped lower geometry 104. In other embodiments (not shown) the sidewall 110 may be a separate component or a component of the upper geometry 102. Whatever the embodiment, the sample gap 105 may be located between the upper geometry 102 and the lower geometry 104 and within the defined perimeter of the sidewall 110 such that the powder sample 101 may be locatable in the sample gap 105 such that the first electrode 112 and the second electrode 114 are in contact with the powder sample 101. The rheometer 100 includes a mechanical measurement system 130 configured to measure mechanical properties of the powder sample 101 located in the sample gap during the rheological test. The mechanical measurement system 130 may include or be operably connected to the sensor system 123. Additionally or alternatively, the mechanical measurement system 130 may include one or more sensors configured to contact the sample during rheological measurements. These one or more sensors (not shown) may be located, for example, in the upper geometry 104, the bottom surface 108 of the lower geometry 104 and/or the sidewall 110. While shear stress may be measured by torque times a geometry factor using the sensor system 123, it is also conceivable for a force sensor to be coupled at a known radius from the axis of rotation within, for example, the side wall 110. Further, shear strain may be measured using the optical encoder included in the sensor system 123, described hereinabove, by multiplying the encoder position of the rotating geometry by a geometry factor.

The mechanical measurement system 130 may include a computer processor and/or system 150 connected to the sensor system and configured to measure, calculate and/or otherwise determine or process mechanical properties of the powder sample 101 during rheological testing in real time. Thus, the mechanical measurement system 130 may be configured to continuously measure shear stress and/or strain rate over time and/or compression over time. In some embodiments, the mechanical measurement system 130 may include one or more sensors, including force sensors, torque sensors, displacement sensors, or the like. The computer system 150 may be configured to provide an analysis of time-dependent behavior of the electrical properties of the powder sample based on the continuously measured shear stress and/or strain rate and/or compression force.

During rheological testing, the powder sample 101 may be mechanically compressed by applying a downward force F1 to the upper geometry 102 while the lower geometry 104 is stationary relative to the upper geometry 102. Thus, the upper geometry 102 may be configured to move vertically apply a controlled normal force and/or a known sample gap, for example. Normal stress may thereby be controlled during experimentation by moving the upper geometry 102 vertically toward and/or away from the lower geometry 104. This functionality is important in both compressibility and shear testing since shear testing typically measures shear strength as a function of normal force, whereas compressibility measures a gap change vs an applied normal force with zero rotational shear. Simultaneously in some embodiments, a mechanical shearing force may be applied to the powder sample 101 by applying a rotational force F2 to the powder sample 101 through rotation of the shaft 120. These forces may be sensed by the sensor system 123, may be detected by the mechanical measurement system 130, and may result in a deformation, melting and/or otherwise alter the electrode binder (in the case of battery electrode powder applications) of the powder sample 101 in the gap 105 between the geometries 102, 104. Mechanical deformation can be characterized in terms of the shear stress and the shear strain. From these quantities and the dimensions of the sample, a shear modulus may be calculated. For example, measurements can be taken about the viscoelastic behavior in which the shear modulus is independent of the shear strain, and more specifically, the stress-strain relationship to understand the flow/deformation properties of the powder sample 101.

In the embodiment shown, the upper geometry 102 includes the first electrode 112 configured to contact the sample 101 within the sample gap 105. Similarly, the lower geometry includes the second electrode 114. Combined the electrodes 112, 114 are configured for forming an electric field in the sample. As shown, the top plate 102 operates as a passive conductor to create a path that extends between the first electrode 112 and the second electrode 114, through the sample 101. Thus, in this embodiment the first electrode 112 is a plate extending across a surface of the upper geometry 102, and wherein the second electrode 114 is a plate extending across a bottom surface of the lower geometry 108.

In the embodiment shown, the sidewall 110 may be made of an electrically insulating material. The insulating material may be configured to facilitate the electric fields created by the electrodes 112, 114 to flow through the powder sample. In particular, the sidewall 110 may be configured to facilitate a desirable direction alignment of the electrical fields through the powder sample, to for example facilitate mathematical evaluation of intrinsic material properties such as conductivity, permeability, etc. as well as to create a desirable orientation of the field with respect to the shear gradient (e.g. perpendicular or parallel). The sidewalls 110 may also be thermally conductive for better temperature control. Examples of materials for the sidewalls 110 include alumina ceramic, aluminum nitride, and boron nitride. However, any generally thermally conductive, electrically insulating ceramics may be suitable for the insulative sidewalls 110. In some embodiments, it may be preferential that the shear head of the upper geometry 102 and cup bottom of the lower geometry 108 use conductive plates (bottom and top plates) with electrically insulating vanes as well.

In some embodiments, an external instrument such as an LCR meter can be coupled to the first electrode 112 and second electrode 114 to apply an oscillating voltage to the rheometer 100. The applied voltage, frequency, and so on can be controlled by the external instrument, such as the computer processor and/or system 150. The LCR meter may include sensors to measure the current flow of other resulting electrical signals from the applied voltage. A processor (not shown) can include program code to synchronize the electrical measurements with the rheology measurements in time.

In some embodiments, the shaft 120 may include a coupling (not shown) formed of an insulative material such as plastic. The coupling may connect the top plate 102 to the shaft 120 and electrically isolate the top plate 102 from the shaft 120 and an environment where current may be present. The electrodes 112, 114 in the upper and lower geometries 102, 104 have opposite polarity voltages that are isolated from each other so that the electrodes 112, 114 form potential across the sample gap 105 and through the sample 101. Each electrode 112, 114 can be connected to a voltage source, for example, a high potential and low potential connector, respectively, via conductive wires 121a, 121b, respectively. The conductive wires 121a, 121b permit the voltage source to apply an oscillating voltage to the electrodes 112, 114 and measure a current flow that can be used by the computer processor and/or system 150 to determine the impedance in the sample gap 15 during the mechanical rheological testing described above. This can be performed over time to determine the conductive and capacitive components of the reactance, as well as any other electrical properties, such as inductance, or the like.

As previously described, the rheometer 100 measures viscosity or elastic properties of the material sample by applying a torque by the motor assembly 122 to the drive shaft 120 and top plate 102. The motor 122 may be constructed to provide little or no additional torque so that rheological measurements rely on most or all of the resistance provided by the material sample to reduce errors. For example, the motor 122 can include air bearings or the like so that the drive shaft “floats” or is surrounded by air so that no external elements except for air and the sample 101 are in contact with the drive shaft 120 to allow as much torque on the shaft 120 as possible to come from the powder sample 101. The powder sample 101 may experience a viscous resistance force when a rotational speed is imposed. As described above, in preferred embodiments, the sensor system 123 may include an optical encoder for measuring the rotational rate of the top geometry 102. In some embodiments, the sensor system 123 includes a force sensor that can continuously measure a rate of deformation, shear stress, and strain rate, allowing for an analysis of time-dependent behavior. An electrical current applied to the motor 122 forms a magnetic field which produces an electrical torque resulting in the rotation of the drive shaft 120. In some embodiments, the sensor system 123 includes a current sensor that measures the motor current, and the torque signal can be calculated using the computer processor 150 from the motor current. Still further, the sensor system 123 may include a vertical displacement sensor for determining the vertical displacement position of the shaft 120. Electrical measurements can be determined at the same time using the electrodes 112, 114 to form an electric field to measure current flow. By doing this, the shear stress/strain mechanical properties can be related to the electrical properties being measured by the computer system 150 in real time. The computer system 150 may be configured to receive this information and correlate current flow measurements determined by the electrical measurement system 140 with the torsional force measurements determined by the mechanical measurement system 130. Thus, the computer system 150 configured to calculate properties over time based on information obtained by the at least one of the electrical measurement system 140 and the mechanical measurement system 130.

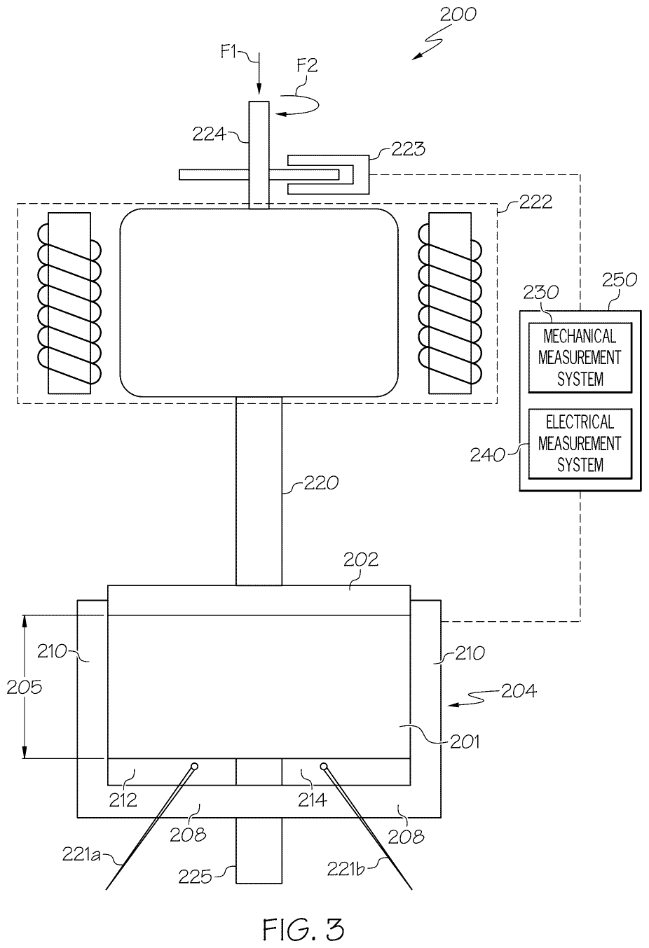

FIGS. 3-6 show variations of the concepts described hereinabove with respect to FIG. 2. However, FIGS. 3-6 show that the electrodes may be placed in different locations than the embodiment shown in FIG. 2. Other than the electrode location difference, the embodiments shown in FIGS. 3-6 may operate in the manner described hereinabove and shown in FIG. 2 in order to achieve the same functions measuring electrical properties of powder samples during rheological testing, and more particularly during shearing of the sample.

FIG. 3 depicts a side schematic view of another rheometer 200 that includes electrodes for the measurement of electrical properties of powder samples during rheological testing, in accordance with one embodiment. The rheometer 200 may be similar to the rheometer 100 described herein above. Thus, the rheometer 200 includes an upper geometry 202 (like the upper geometry 102) and a lower geometry 204 (like the lower geometry 104) between which a powder sample 201 is placed, separated by a gap 205. The rheometer includes a shaft 220 (like the shaft 120) that couples the upper geometry 202 to a combined motor transducer 222 (like the motor 122) which is configured to provide both torque and/compressive force on the upper geometry 202. A sensor system 223 (like the sensor system 123) which includes a rotating component 224 (like rotating component 124) configured to rotate with the shaft 220 provides a means of sensing the rotational displacement, vertical displacement and/or forces or torque created by the motor 222 and produced in the shaft 220. The lower geometry 204 includes a cup-shaped structure which has side walls 210 (like side walls 110) extending from a bottom surface 208 (like bottom surface 108) which is attached to a lower shaft 225 (like lower shaft 125). The rheometer 200 further includes a computer system 250 (like computer system 150), a mechanical measurement system 230 (like mechanical measurement system 130), and an electrical measurement system 240 (like electrical measurement system 140) which are connected to sensors as described hereinabove with reference to the rheometer 100.

Unlike the rheometer 100, the rheometer 200 does not have an electrode located in the upper geometry. Rather, the rheometer 200 includes a first electrode 212 located on one side of the bottom surface 208 of the lower geometry 204 and a second electrode 214 located on an opposite side of the bottom surface 208 of the lower geometry 204. These electrodes 212, 214 may be separated by an insulative portion of the bottom surface 208. Thus, an electrical field may flow through the powder sample 201 between the first electrode 212 and the second electrode 214. Conductive wires 221a, 221b may be attachable to the first and second electrodes 212, 214, respectively, and may permit voltage to be applied to the electrodes 212, 214. While not shown, it is further contemplated that the electrodes 212, 214 may be each located on both sides of the upper geometry 202, rather than the lower geometry 204. Whatever the embodiment, either or both of the upper geometry 202 and the lower geometry 204 may include insulative vanes. Further, the electrodes 212, 214 may include liquid contacts, including using electrically conductive liquid to conduct electricity from the electrodes 212, 214 to a moving geometry in order to minimize mechanical torque contribution and improve conductivity between electrical contacts.

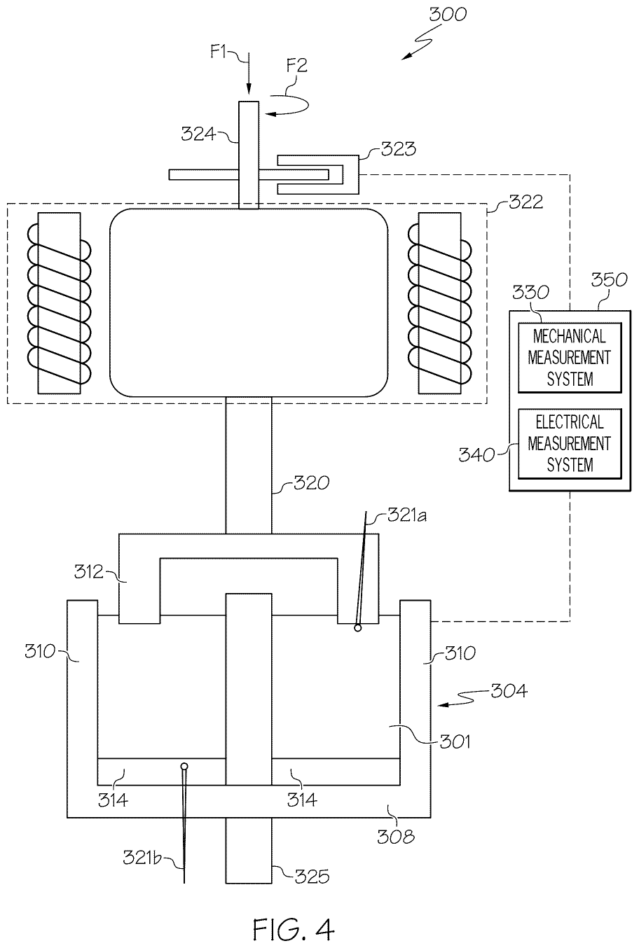

FIG. 4 depicts a side schematic view of another rheometer 300 that includes electrodes for the measurement of electrical properties of powder samples during rheological testing, in accordance with one embodiment. The rheometer 300 may be similar to the rheometer 100 described herein above. Thus, the rheometer 300 includes an upper geometry 302 (like the upper geometry 102) and a lower geometry 304 (like the lower geometry 104) between which a powder sample 301 is placed, separated by a gap 305. The rheometer includes a shaft 320 (like the shaft 120) that couples the upper geometry 302 to a combined motor transducer 322 (like the motor 122) which is configured to provide both torque and/compressive force on the upper geometry 302. A sensor system 323 (like the sensor system 123) which includes a rotating component 324 (like rotating component 124) configured to rotate with the shaft 320 provides a means of sensing the rotational displacement, vertical displacement and/or forces or torque created by the motor 322 and produced in the shaft 320. The lower geometry 304 includes a cup-shaped structure which has side walls 310 (like side walls 110) extending from a bottom surface 308 (like bottom surface 108) which is attached to a lower shaft 325 (like lower shaft 125). The rheometer 300 further includes a computer system 350 (like computer system 150), a mechanical measurement system 330 (like mechanical measurement system 130), and an electrical measurement system 340 (like electrical measurement system 140) which are connected to sensors as described hereinabove with reference to the rheometer 300.

Unlike the rheometer 100, the rheometer 300 does not have a flat disk-shaped surface electrode attached to the upper geometry 102. Rather, the rheometer 300 includes a ring-shaped upper electrode 312 extending around the circumference of the cup shaped lower geometry 304. The ring-shaped upper electrode 312 is configured to surround a middle post 315 located within the cup shaped lower geometry 304. A circular lower electrode 314 surrounds the middle post 315. Conductive wires 321a, 321b may be attachable to the first and second electrodes 312, 314, respectively, and may permit voltage to be applied to the electrodes 312, 314. Similar to the embodiment shown in FIG. 1, an electrical field may flow through the powder sample 301 between the first electrode 312 and the second electrode 314.

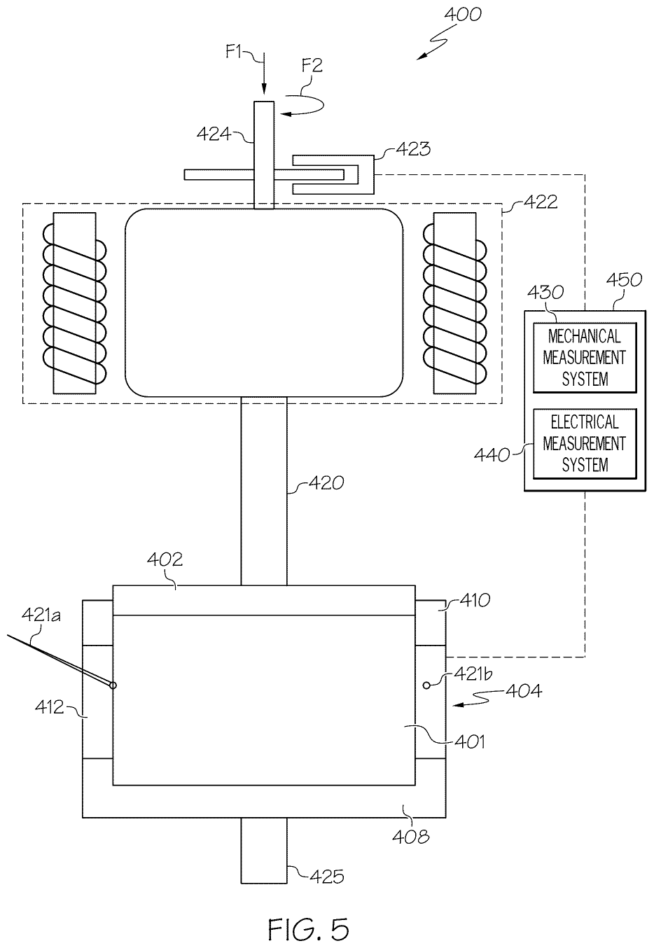

FIG. 5 depicts a side schematic view of another rheometer 400 that includes electrodes for the measurement of electrical properties of powder samples during rheological testing, in accordance with one embodiment. The rheometer 400 may be similar to the rheometer 100 described herein above. Thus, the rheometer 400 includes an upper geometry 202 (like the upper geometry 102) and a lower geometry 404 (like the lower geometry 104) between which a powder sample 401 is placed, separated by a gap 405. The rheometer includes a shaft 420 (like the shaft 120) that couples the upper geometry 402 to a combined motor transducer 422 (like the motor 122) which is configured to provide both torque and/compressive force on the upper geometry 402. A sensor system 423 (like the sensor system 123) which includes a rotating component 424 (like rotating component 124) configured to rotate with the shaft 420 provides a means of sensing the rotational displacement, vertical displacement and/or forces or torque created by the motor 422 and produced in the shaft 420. The lower geometry 404 includes a cup-shaped structure which has side walls 410 (like side walls 110) extending from a bottom surface 408 (like bottom surface 108) which is attached to a lower shaft 425 (like lower shaft 125). The rheometer 400 further includes a computer system 450 (like computer system 150), a mechanical measurement system 430 (like mechanical measurement system 130), and an electrical measurement system 440 (like electrical measurement system 140) which are connected to sensors as described hereinabove with reference to the rheometer 100.

Unlike the rheometer 100, the rheometer 400 does not have a flat disk-shaped surface electrode attached to the upper geometry 102 and the lower geometry 104. Rather, the rheometer 400 includes a first electrode 412 attached to a first side of the side wall 410 of the lower geometry 404, and a second electrode 414 attached to a second side of the side wall 410 of the lower geometry 404. Conductive wires 421a, 421b may be attachable to the first and second electrodes 412, 414, respectively, and may permit voltage to be applied to the electrodes 412, 414. Similar to the embodiment shown in FIG. 1, an electrical field may flow through the powder sample 401 between the first electrode 412 and the second electrode 414.

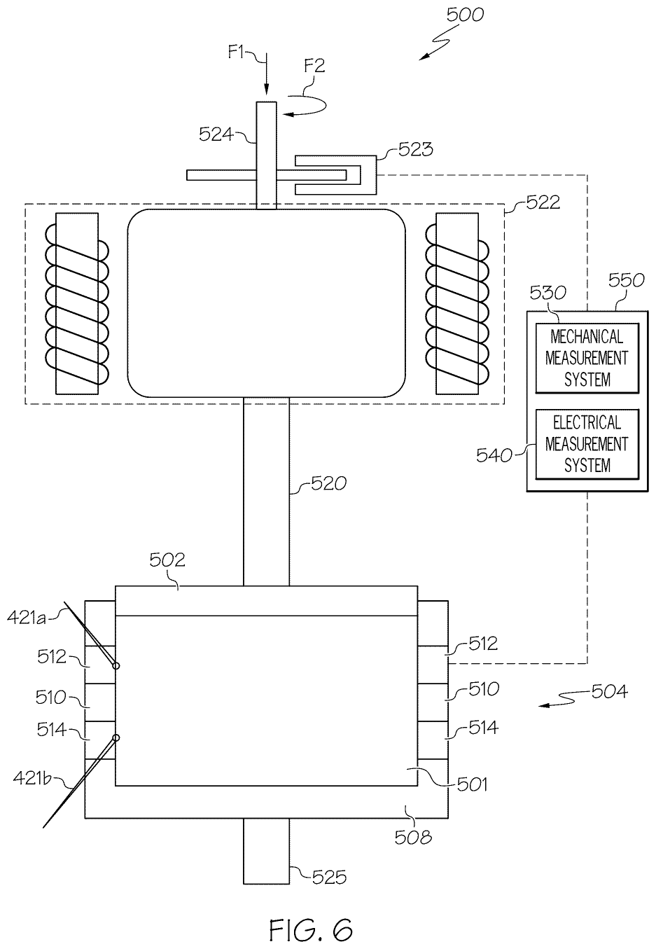

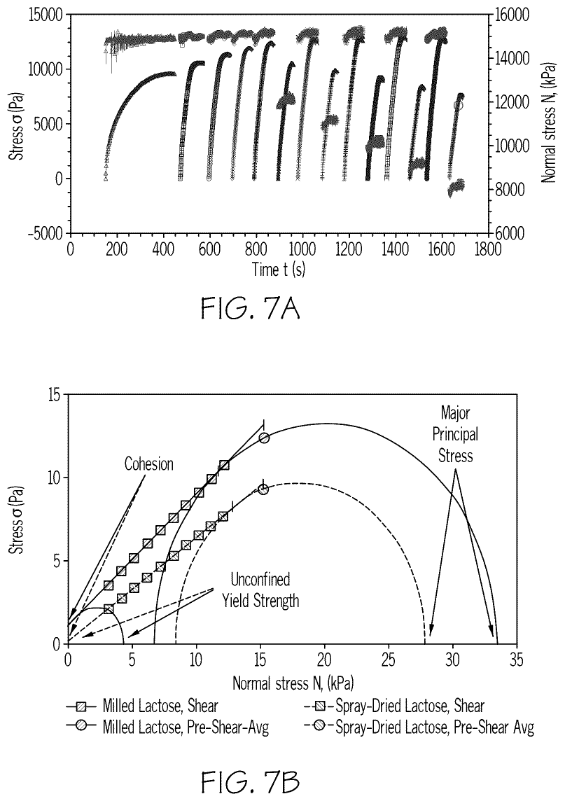

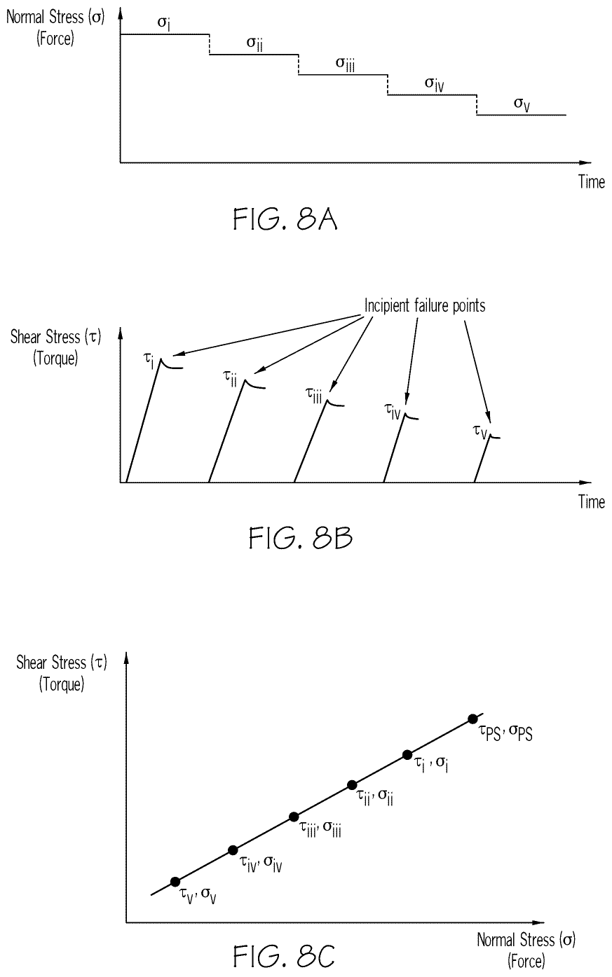

FIG. 6 depicts a side schematic view of another rheometer 500 that includes electrodes for the measurement of electrical properties of powder samples during rheological testing, in accordance with one embodiment. The rheometer 500 may be similar to the rheometer 100 described herein above. Thus, the rheometer 500 includes an upper geometry 502 (like the upper geometry 102) and a lower geometry 504 (like the lower geometry 104) between which a powder sample 501 is placed, separated by a gap 505. The rheometer includes a shaft 520 (like the shaft 120) that couples the upper geometry 502 to a combined motor transducer 522 (like the motor 122) which is configured to provide both torque and/compressive force on the upper geometry 502. A sensor system 523 (like the sensor system 123) which includes a rotating component 524 (like rotating component 124) configured to rotate with the shaft 520 provides a means of sensing the rotational displacement, vertical displacement and/or forces or torque created by the motor 522 and produced in the shaft 520. The lower geometry 504 includes a cup-shaped structure which has side walls 510 (like side walls 110) extending from a bottom surface 508 (like bottom surface 108) which is attached to a lower shaft 525 (like lower shaft 125). The rheometer 500 further includes a computer system 550 (like computer system 150), a mechanical measurement system 530 (like mechanical measurement system 130), and an electrical measurement system 540 (like electrical measurement system 140) which are connected to sensors as described hereinabove with reference to the rheometer 100.

Unlike the rheometer 100, the rheometer 500 does not have a flat disk-shaped surface electrode attached to the upper geometry 102 and the lower geometry 104. Rather, the rheometer 500 includes a first electrode 512 located circumferentially as a portion of the side wall 510 at a first height, and a second electrode 514 located circumferentially as a portion of the side wall 510 at a second height. Conductive wires 521a, 521b may be attachable to the first and second electrodes 512, 514, respectively, and may permit voltage to be applied to the electrodes 512, 514. Similar to the embodiment shown in FIG. 1, an electrical field may flow through the powder sample 501 between the first electrode 512 and the second electrode 514.

FIGS. 7A-10D depict various testing results of mechanical rheological tests which may be determined by the mechanical measurement systems 150, 250, 350, 450, 550 described hereinabove on powder samples. It should be understood that these test results are representative of the types of rheological testing, including shear testing, a powder sample may be subjected to. Any type of test or powder sample type are contemplated. In accordance to embodiments described herein, electrical properties including conductivity, capacitance, inductance, permittivity and the like may be tested during the various mechanical rheological tests using the structures and systems described and shown in FIGS. 2-6.

FIG. 7A depicts the results of a mechanical rheological shear test on a powder sample. In particular, shown are the results of a shear test on a powder milled lactose sample. FIG. 7A depicts stress and normal stress over time on the milled lactose sample during the shear test. FIG. 7B depicts further results from the mechanical rheological shear test of FIG. 7A. In particular, FIG. 7B depicts the stress vs normal stress of both milled and spray-dried lactose, including pre-shear averages.

FIG. 8A depicts the results of a mechanical rheological wall friction test on a powder sample. Shown are the results of a wall friction test on a powder sample, particularly depicting normal stress over time. FIG. 8B depicts further results from the mechanical rheological wall friction test of FIG. 8A. In particular, depicted is shear stress over time, including incipient failure points during the wall friction test. FIG. 8C depicts further results from the mechanical rheological wall friction test of FIG. 8A. In particular, depicted is shear stress vs normal stress during the wall friction test of the powder sample.

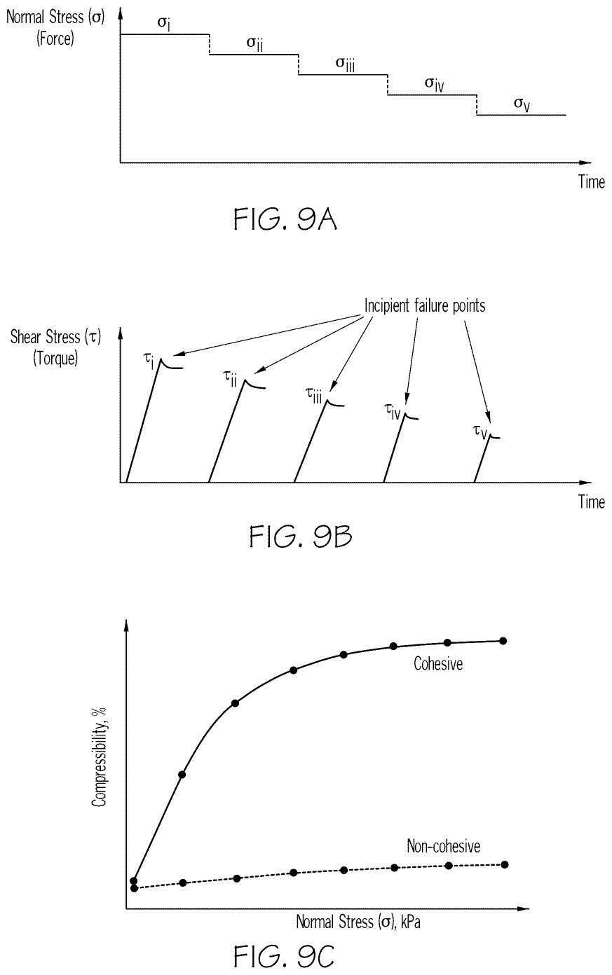

FIG. 9A depicts the results of a mechanical rheological compressibility test on a powder sample. Shown are the results of a compression test on a powder sample, particularly depicting normal stress over time. FIG. 9B depicts further results from the mechanical rheological compressibility test of FIG. 9A. In particular, depicted is shear stress over time, including incipient failure points during the compressibility test. FIG. 9C depicts further results from the mechanical rheological compressibility test of FIG. 9A. In particular, depicted is shear stress vs normal stress during the compressibility test of the powder sample.

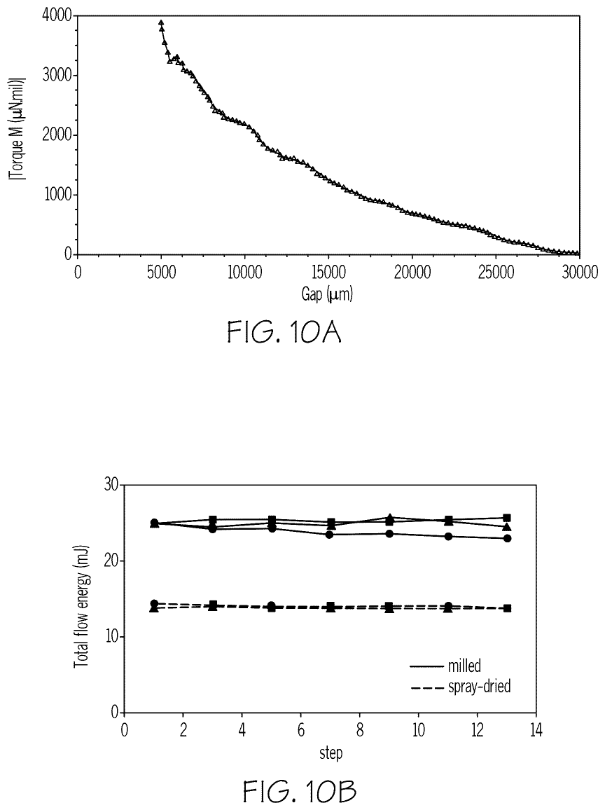

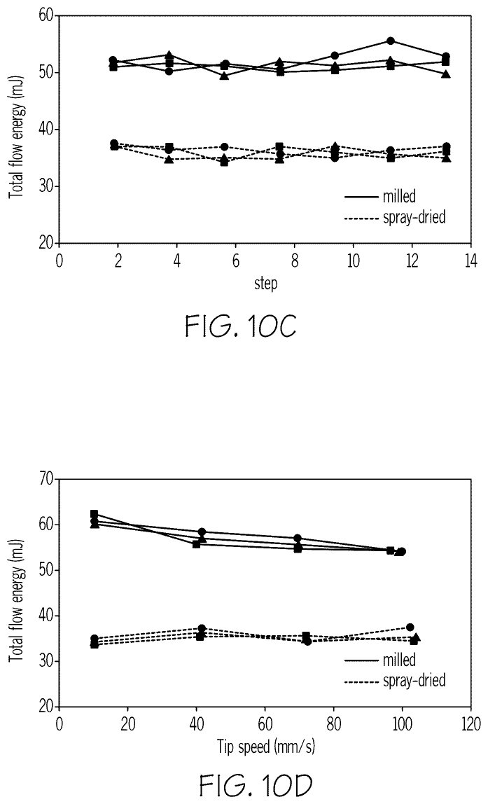

FIG. 10A depicts the results of a mechanical rheological flow test on a powder sample. Shown are the results of a flow test in which energy is measured which is required to induce bulk flow of a powder bed. FIG. 10A particularly depicts torque vs gap (in microns) for milled lactose flowability. FIG. 10B depicts further results of the mechanical rheological flow test of FIG. 10A. Depicted is the total flow energy per step of milled and spray-dried lactose for unconfined flow. FIG. 10C depicts further results of the mechanical rheological flow test of FIG. 10A. Depicted is the total flow energy per step of milled and spray-dried lactose for confined flow. FIG. 10D depicts further results of the mechanical rheological flow test of FIG. 10A. Depicted is total flow energy vs tips speed of milled and spray-dried lactose.

Methods for performing electrical and rheological measurements of a powder sample are also contemplated herein. For example, methods include providing an apparatus for performing electrical and rheological measurements of a powder sample. The apparatus may include an upper geometry, a lower geometry, a sidewall forming a perimeter between the upper geometry and the lower geometry, and a sample gap located between the upper geometry and the lower geometry and within the perimeter of the sidewall. Methods may include providing a powder sample within the sample gap such that the first electrode and the second electrode are in contact with the powder sample. Methods include performing a rheological test on the powder sample and measuring, by an electrical measurement system connected to each of the first electrode and the second electrode, electrical properties of the powder sample during the rheological test. Methods also include measuring, by a mechanical measurement system, mechanical properties of the powder sample during the rheological test.

Methods further include performing a shear test on the powder sample by rotating the upper geometry relative to the lower geometry while applying a normal stress on the powder sample and/or performing a compression test on the powder sample by moving the upper geometry vertically toward the lower geometry.

Methods still further include determining a capacitance of the powder sample during the rheological test and/or determining the conductivity of the powder sample during the rheological test.

Still further, methods include calculating, by a computer system connected to at least one of the electrical measurement system and the mechanical measurement system, properties over time based on information obtained by the at least one of the electrical measurement system and the mechanical measurement system.

Methods may further include continuously measuring, by the mechanical measurement system, shear stress and/or strain over time, and providing, by the computer system, an analysis of time-dependent behavior of the electrical properties of the powder sample based on the continuously measured shear stress and/or strain rate.

Alternatively or additionally, methods may include continuously measuring, by mechanical measurement system, compression force over time, and providing, by the computer system, an analysis of time-dependent behavior of the electrical properties of the powder sample based on the continuously measured compression force over time.

While various examples have been shown and described, the description is intended to be exemplary, rather than limiting and it should be understood by those of ordinary skill in the art that various changes in form and detail may be made therein without departing from the scope of the invention as recited in the accompanying claims.

What is claimed is:

1. An apparatus for performing electrical and rheological measurements of a powder sample, comprising:
an upper geometry including a first electrode;
a lower geometry including a bottom surface and a second electrode, wherein the upper geometry is configured to rotate relative to the lower geometry;
a sidewall forming a perimeter located between the upper geometry and the bottom surface of the lower geometry;
a sample gap located between the upper geometry and the lower geometry and within the perimeter of the sidewall, the powder sample locatable in the sample gap such that the first electrode and the second electrode are in contact with the powder sample;
an electrical measurement system operably connected to each of the first electrode and the second electrode configured to measure electrical properties of the powder sample during a rheological test; and
a mechanical measurement system configured to measure mechanical properties of the powder sample located in the sample gap during the rheological test.

2. The apparatus of claim 1, wherein the lower geometry is stationary and the upper geometry is configured to rotate to perform a shear test.

3. The apparatus of claim 2, wherein the upper geometry is configured to move vertically to to reduce the sample gap and/or apply a controlled normal force.

4. The apparatus of claim 1, wherein the sidewall is made of an electrically insulating material.

5. The apparatus of claim 1, wherein the first electrode is a plate extending across a surface of the upper geometry, and wherein the second electrode is a plate extending across a surface of the lower geometry.

6. The apparatus of claim 1, wherein at least one of the first electrode and the second electrode is a ring-shaped electrode.

7. The apparatus of claim 1, wherein at least one of the upper geometry and the lower geometry include electrically insulating vanes.

8. The apparatus of claim 1, further comprising a computer system connected to at least one of the electrical measurement system and the mechanical measurement system, the computer system configured to calculate properties over time based on information obtained by the at least one of the electrical measurement system and the mechanical measurement system.

9. The apparatus of claim 8, wherein the electrical properties include at least one of capacitance and conductivity.

10. The apparatus of claim 8, wherein the mechanical measurement system is configured to continuously measure shear stress and/or strain rate over time, and wherein the computer system is configured to provide an analysis of time-dependent behavior of the electrical properties of the powder sample based on the continuously measured shear stress and/or strain rate.

11. The apparatus of claim 8, wherein the mechanical measurement system is configured to continuously measure compression force over time, and wherein the computer system is configured to provide an analysis of time-dependent behavior of the electrical properties of the powder sample based on the continuously measured compression force.

12. A method for performing electrical and rheological measurements of a powder sample, comprising:
providing an apparatus for performing electrical and rheological measurements of a powder sample, the apparatus including an upper geometry, a lower geometry, a sidewall forming a perimeter between the upper geometry and the lower geometry, and a sample gap located between the upper geometry and the lower geometry and within the perimeter of the sidewall;
providing a powder sample within the sample gap such that the first electrode and the second electrode are in contact with the powder sample;
performing a rheological test on the powder sample;
measuring, by an electrical measurement system connected to each of the first electrode and the second electrode, electrical properties of the powder sample during the rheological test; and
measuring, by a mechanical measurement system, mechanical properties of the powder sample during the rheological test.

13. The method of claim 12, wherein the performing the rheological test further includes:
performing a shear test on the powder sample by rotating the upper geometry relative to the lower geometry while applying a normal stress on the powder sample.

14. The method of claim 12, wherein the performing the rheological test further includes:
performing a compression test on the powder sample by moving the upper geometry vertically toward the lower geometry.

15. The method of claim 12, further comprising determining a capacitance of the powder sample during the rheological test.

16. The method of claim 12, further comprising determining the conductivity of the powder sample during the rheological test.

17. The method of claim 15, further comprising calculating, by a computer system connected to at least one of the electrical measurement system and the mechanical measurement system, properties over time based on information obtained by the at least one of the electrical measurement system and the mechanical measurement system.

18. The method of claim 17, wherein the electrical properties include at least one of capacitance and conductivity.

19. The method of claim 17, further comprising:
continuously measuring, by the mechanical measurement system, shear stress and/or strain over time; and
providing, by the computer system, an analysis of time-dependent behavior of the electrical properties of the powder sample based on the continuously measured shear stress and/or strain rate.

20. The method of claim 17, further comprising:
continuously measuring, by the mechanical measurement system, compression force over time;
providing, by the computer system, an analysis of time-dependent behavior of the electrical properties of the powder sample based on the continuously measured compression force over time.

21. An apparatus for performing electrical and rheological measurements of a powder sample, comprising:
an upper geometry;
a lower geometry, wherein the upper geometry is configured to rotate relative to the lower geometry;
a sidewall forming a perimeter located between the upper geometry and the lower geometry;
a sample gap located between the upper geometry and the lower geometry and within the perimeter of the sidewall, the powder sample locatable in the sample gap such that a first electrode and a second electrode are in contact with the powder sample;
an electrical measurement system operably connected to each of the first electrode and the second electrode configured to measure electrical properties of the powder sample during a rheological shear test; and
a mechanical measurement system configured to measure mechanical properties of the powder sample located in the sample gap during the rheological shear test.
